(19) United States
(12) Patent Application Publication
(10) Pub. No.: US 2007/0069543 A1
(43) Pub. Date: Mar. 29, 2007

(54) Retractable storage device for a motor vehicle

(76) Inventor: Freddy Stoof, Horbour Wihr (FR)

Correspondence Address: YOUNG & THOMPSON, 745 SOUTH 23RD STREET, 2ND FLOOR, ARLINGTON, VA, 22202, US

(21) Appl. No.: 10/571,674

(22) PCT Filed: Sep. 14, 2004
(86) PCT No.: PCT/FR04/02331

§ 371 Date: Mar. 13, 2006

(30) Foreign Application Priority Data
Sep. 16, 2003 (FR) 0310863

(51) Int. Cl. B60N 3/12

(52) U.S. Cl. 296/37.8; 296/37.12

(57) ABSTRACT

A storage device (1), in particular for a motor vehicle (2) including a bottom wall (10) fixed to a vehicle, a movable wall which is embodied in one piece and forms a door (14) and a lateral wall (12). The inventive device can take up the following positions: an unfolded closed position, wherein the bottom wall (10), the lateral wall (12) and the door (14) define therebetween a first substantially closed storing volume (32), an unfolded open position, wherein the device forms an access opening (34) to the first storing volume and a retracted closed position, wherein the access opening is closed by the door and wherein the bottom wall (10), the lateral wall (12) and the door (14) define therebetween a second storing volume (32) which is substantially enclosed in the first storing volume.

The invention relates to a storage device, in particular for a motor vehicle. It is particularly intended to be arranged in the dashboard in order to constitute a glove box, but it can also be arranged in particular in a trim panel or in the boot.

Document DE-23 63 163 describes a storage device having a single pocket, and document DE-35 10 405 describes a storage device having an articulated door. No document describes a door whose articulated side can assume a plurality of positions which provide different storage spaces.

The object of the invention is to improve the ergonomics of the vehicle by increasing the modularity of the passenger space and/or the boot.

To this end, according to the invention, the storage device comprises a base wall which is intended to be fixed relative to the vehicle, a movable wall in one piece which forms a door and a deformable lateral wall which extends between the base wall and the door, said device having:

a closed deployed position in which the base wall, the lateral wall and the door together define a substantially closed first storage space,

an open deployed position in which the device has an opening for access to the first storage space, the movement from the closed position to the open position being brought about by displacement of the door so that said opening is blocked by the door when the device is in the closed position,

a closed retracted position in which said access opening is blocked by the door and the base wall, the lateral wall and the door together define a substantially closed second storage space, below said first storage space.

The spatial requirement of the device is thus variable, which allows the space at the inner side of the vehicle to be optimised.

Advantageously, according to the invention, in the closed retracted position, the door substantially comes into contact with said base wall, so that the second storage space is substantially zero.

By completely folding up the device, most of the storage space is thus recovered to the benefit of the passenger space.

Additionally, the device advantageously comprises a rigid housing which is fitted to said base wall.

According to another feature in accordance with the invention, the storage device further comprises means for articulation in terms of rotation in order to move the door between the closed deployed position and the open deployed position, and said articulation means are mounted so as to slide in a sliding rail in order to move the device from the closed retracted position to the closed deployed position and vice-versa.

This solution is relatively simple to implement, robust and ergonomic.

Additionally, and in accordance with the invention, the device further comprises means for indexing the articulation means in said sliding rail.

Positioning and retaining the device in position are thus improved.

According to another advantageous feature of the invention, using the articulation means, the door is movable in terms of rotation between the closed retracted position and an open retracted position in which said device affords access to said second storage space.

It is thus not necessary to deploy the device in order to access the contents thereof, with the result that reducing the spatial requirement thereof does not impair its ease of use.

The invention will be appreciated even more clearly from the following description, given with reference to the appended drawings, in which:

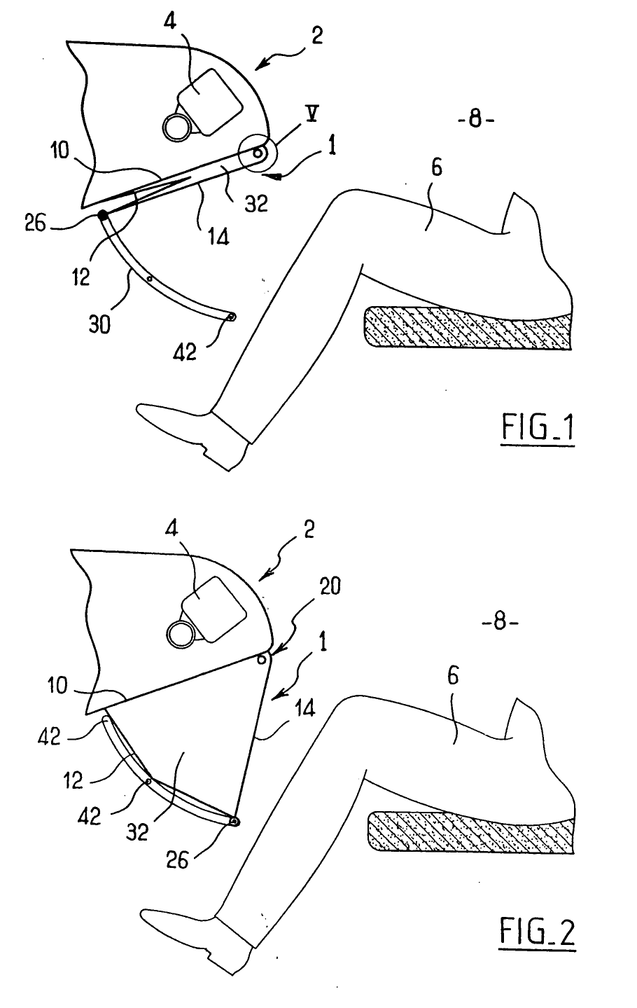

FIG. 1 is a schematic cross-section of a device according to the invention, in a completely closed retracted position,

FIG. 2 illustrates the device of FIG. 1 in the closed deployed position,

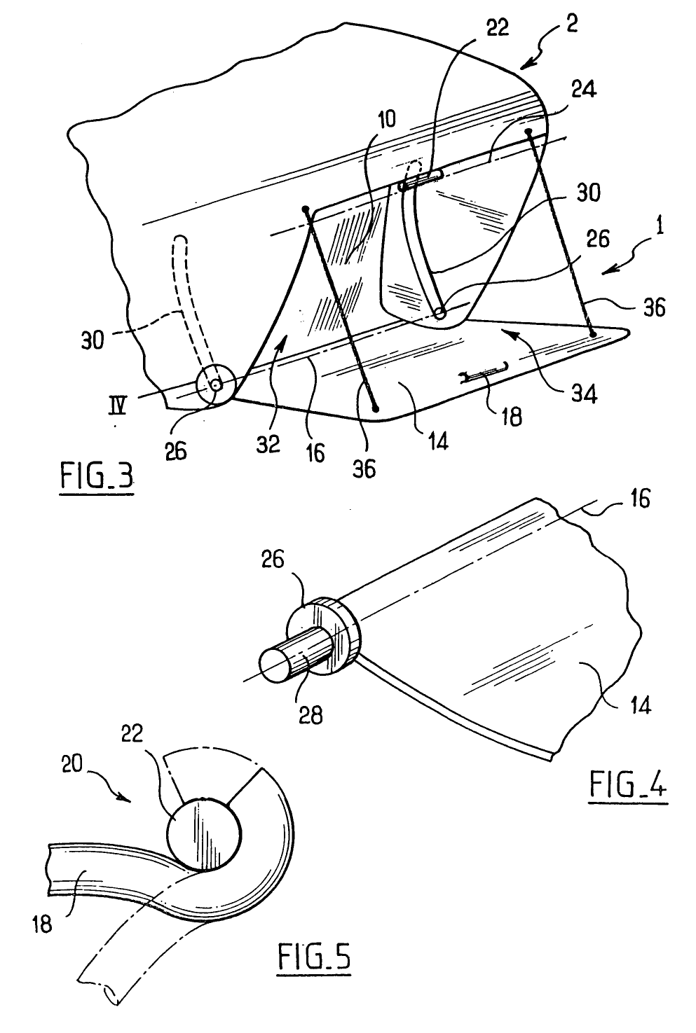

FIG. 3 is a perspective view of the device of FIG. 1 in the open deployed position,

FIG. 4 illustrates the zone indicated IV in FIG. 3, without the dashboard, drawn to an enlarged scale,

FIG. 5 illustrates locking means in the zone indicated V in FIG. 1, drawn to an enlarged scale,

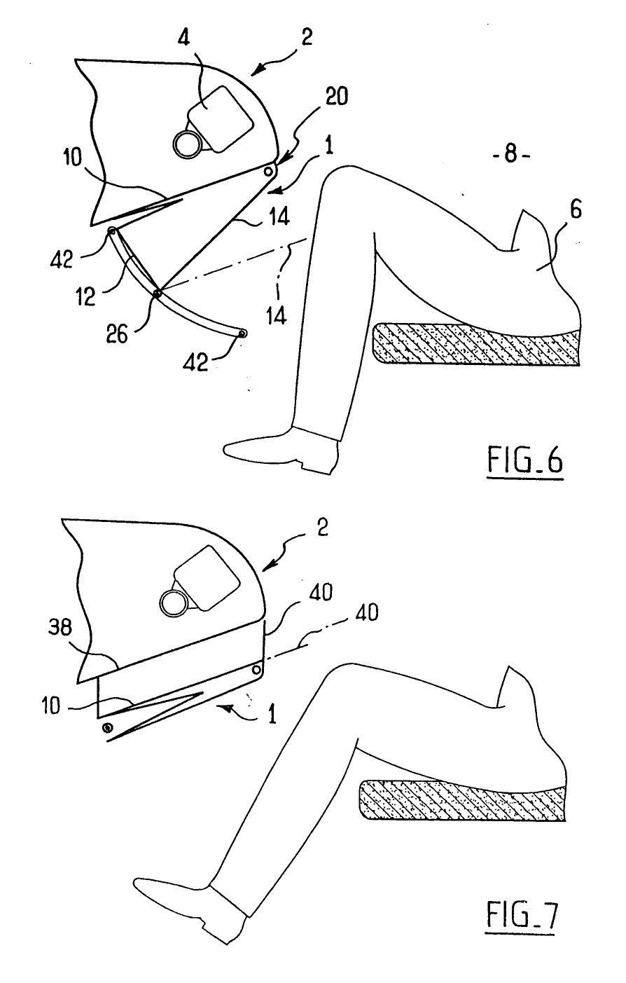

FIG. 6 illustrates the device of FIG. 1 in the partially retracted position,

FIG. 7 illustrates a variant of the device.

The Figures illustrate a glove box 1 which is arranged in the lower portion of a dashboard 2, an airbag module 4 being arranged in the upper portion of the dashboard.

The glove box 1 faces a passenger 6 seated inside a passenger space 8 of a motor vehicle. It comprises a rigid base wall 10 which is fixed to the dashboard 2, a rigid single-piece door 14 which is articulated in terms of rotation relative to the dashboard 2 in accordance with an axis of rotation 16 and a flexible lateral wall 12 which is folded in the manner of an accordion and which extends over three sides between the base wall 10 and the door 14.

The door 14 can be moved about an axis of rotation 16 between a closed retracted position in which the base wall 10, the lateral wall 12 and the door 14 together define a substantially closed inner space 32 and an open retracted position in which the device has an opening for access to the inner space 32.

The door 14 is held in a closed position, in a releasable manner, using locking means 20 which are constituted by a retaining bar 22 which extends in an extension direction 24 parallel with the axis of rotation 16 and a hook 18 which pivots about the extension direction 24 of the retaining bar 22. The retaining bar 22 is fixed to the dashboard 2, whilst the rotation of the hook 18 is controlled by means of a control handle. By acting on the control handle, the hook 18 is released from the bar 22.

As illustrated in FIGS. 3 and 4, the lower portion of the door 14 is retained at each end of the door in accordance with the axis of rotation 16 by means of an annular ring 26 and a retractable stud 28. Each annular ring 26 slides in a groove 20 which forms a sliding rail and which is arranged in the dashboard. These grooves 20 extend in a circular direction so as to maintain a constant distance between the axis of rotation 16 and the extension direction 24.

The retractable studs 28 are inserted into cavities 42 which have a complementary shape and which are arranged in the dashboard 2 at predetermined locations (in this instance, three per groove) in order to retain the articulation axis 16 at that location. The studs 28 are mounted on springs. Their retraction is carried out using conventionally known means and is controlled using a handle which can be the same as that which acts on the hook 18.

As illustrated in FIG. 1, the glove box is in a completely retracted position and the door 14 is closed using the locking means 20. In this position, the glove box has a minimum spatial requirement, the lateral wall 12 is folded in the manner of an accordion and the door is substantially in contact with the base wall 10. The inner space 32 is almost zero. It would be possible to open the door 14 using the control handle. This does not offer a great advantage in this instance, however, since it is not possible to accommodate an object inside the glove box when it is in a completely retracted position.

By retracting the studs 28, the rings 26 are caused to slide in the grooves 30 until the lateral wall 12 is completely deployed. The glove box is then in the deployed position, illustrated in FIG. 2. It is held in this position by the studs 28 which are inserted into the corresponding cavities 42.

The glove box 1 has a maximum inner space 32. By acting on the control handle, the door 14 is opened in order to access the inner space 32 by means of an opening 34. The door is retained by means of flexible cords 36. By raising the door 14, the hook 18 is moved around the retaining bar 22 and the locking means 20 are automatically activated.

By sliding the rings 26 in the grooves 30, it is also possible to move the glove box 1 into a partially retracted intermediate position illustrated in FIG. 6. In this position, the inner space 32 is substantially equal to half of the maximum inner space. It is possible to readily access the inner space by opening the door 14, as described above. As illustrated with dot-dash lines, even in the open position, the door 14 does not interfere with the legs of the passenger 6.

In FIG. 5, the hook 18 is illustrated with solid lines in the completely retracted position of the glove box 1 and with dot-dash lines in the deployed position of the glove box. This Figure illustrates that the locking means 20 are operational, whatever the position of the glove box.

Although this is, a priori, not very practical, it would be possible to move the articulation axis 16 by sliding the rings 26 in the grooves 30 when the door 14 is open.

FIG. 7 illustrates a construction variant in which a rigid housing 38 provided with a pivoting access hatch 40 is fitted to the base wall 10 of the glove box 1.

1-7. (canceled)

8. Storage device (1), in particular for a motor vehicle (2) comprising a base wall (JO) which is intended to be fixed relative to the vehicle, a movable wall in one piece which forms a door (14) and a deformable lateral wall (12) which extends between the base wall and the door, said device having:
a closed deployed position in which the base wall (10), the lateral wall (12) and the door (14) together define a substantially closed first storage space (32),
an open deployed position in which the device has an opening (34) for access to the first storage space, the movement from the closed position to the open position being brought about by displacement of the door (14) so that said opening is blocked by the door when the device is in the closed position,
a closed retracted position in which said access opening is blocked by the door and the base wall (10), the lateral wall (12) and the door (14) together define a substantially closed second storage space (32), below said first storage space.

9. Storage device according to claim 8, characterized in that, in the closed retracted position, the door (14) substantially comes into contact with said base wall (10), so that the second storage space is substantially zero.

10. Storage device according to claim 9, characterized in that it further comprises a rigid housing (38) which is fitted to said base wall (10).9

11. Storage device according to claim 8, characterized in that:
it further comprises means (26) for articulation in terms of rotation in order to move the door (14) between the closed deployed position and the open deployed position, and
said articulation means are mounted so as to slide in a sliding rail (30) in order to move the device from the closed retracted position to the closed deployed position and vice-versa.

12. Storage device according to claim 11, characterized in that it further comprises means (28, 42) for indexing the articulation means (26) in said sliding rail (30)

13. Storage device according to claim 11, characterized in that, using the articulation means, the door (14) is movable in terms of rotation between the closed retracted position and an open retracted position in which said device has an opening (34) for access to said second storage space.

14. Storage device according to claim 8, characterized in that the door (14) is rigid.

15. Storage device according to claim 12, characterized in that, using the articulation means, the door (14) is movable in terms of rotation between the closed retracted position and an open retracted position in which said device has an opening (34) for access to said second storage space.
